(19) United States
(12) Patent Application Publication
(10) Pub. No.: US 2004/0064571 A1
(43) Pub. Date: Apr. 1, 2004

(54) Configuration management in a distributed platform

(76) Inventor: Petri Nuuttila, Inkoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/415,642

(22) PCT Filed: Oct. 26, 2001
(86) PCT No.: PCT/FI01/00933

(30) Foreign Application Priority Data
Nov. 1, 2000 (FI) 20002402

(51) Int. Cl. G06F 15/16

(52) U.S. Cl. 709/229

(57) ABSTRACT

The invention relates to configuration management and updating a directory service in a distributed platform. The known LDAP (Lightweight Directory Access Protocol) is used for managing the configuration directories of processes and CNS (Corba Notification Service) for handling the notifications of changes in the configuration directories. The configuration directories are situated in a directory service, which is a physically distributed, logically centralized repository (containing databases). Processes, monitoring elements and management elements, etc. use the directory service to get configuration information for their use. When there are changes in the configuration directory of a node, a notification message concerning the change is sent to CNS. CNS distributes the notification message to the processes that are interested in knowing the change.

### FIELD OF THE INVENTION

This invention relates to configuration management and updating a directory service in a distributed platform. A distributed platform can be a large network, such as a telecommunications network or a datacommunications network where databases, servers and users are located in a large area.

### BACKGROUND OF THE INVENTION

FIG. 1 illustrates an example of how the configuration of nodes in a telecommunications network is handled at present. Nodes are network elements, such as servers, switches and multiplexers. A network management system, NMS, (1) handles the configuration of the nodes (2) through a telecommunications management network. Each node contains processes (3) for handling process-specific tasks. Configuration is needed when a node is taken into use and when specific events, such as changes in a network structure, assembling new versions and so on, occur.

In a configuration event one or more processes in a node may need changes. The NMS handles the changes, i.e. configuration, process by process. In other words, configuration has to be done separately for each process. A situation may arise where a change of configuration generates a need to make configuration for another process, in the same or another node. Thus, the NMS needs to make the changes for both the processes in this case.

In another possible situation a node, which is a server, has a backup node elsewhere in the network. In this case, configuration information must be equal in both the nodes, after the changes of configuration too. So at present, configuration and updates are matched for each node. This can be reasonable if there are only a few processes in a node, but when the number of processes is going to be considerable, configuring each node separately becomes a heavy process, not to mention backups. The goal of the invention is to alleviate these drawbacks. This is achieved in a way described in the claims.

### SUMMARY OF THE INVENTION

In the method according to the invention the known LDAP (Light-weight Directory Access Protocol) is used for managing the configuration directories of processes and CNS (Corba Notification Service) for handling the notifications of changes in the configuration directories. The configuration directories are situated in a directory service, which is a physically distributed, logically centralized repository (containing databases). Processes, monitoring elements and management elements, etc. use the directory service to get configuration information for their use. However, LDAP does not support sending notifications of changes so CNS is tied to LDAP for handling the changes in the configuration directories.

When there are changes in the configuration directory of a node, a notification message concerning the change is sent to CNS. CNS distributes the notification message to the processes that are interested in knowing the change. After receiving the message, the processes can update their configuration.

The composition of LDAP and CNS brings modularity to the configuration management. An arrangement according to the invention can be constructed to be transparent so that it is independent of different technologies used in nodes. CNS handles the distribution of run time changes to processes.

### BRIEF DESCRIPTION OF THE DRAWINGS

In the following the invention is described in more detail by means of FIGS. 1-6 in the attached drawings where

FIG. 1 illustrates an example of configuration management at present,

FIG. 2 illustrates an example of configuration management according to the invention,

FIG. 3 illustrates an example of the hierarchical naming model of LDAP,

FIG. 4 illustrates the principle of a notification service,

FIG. 5 illustrates an example of a node according to the invention, implemented using Java,

FIG. 6 illustrates an example of a method according to the invention.

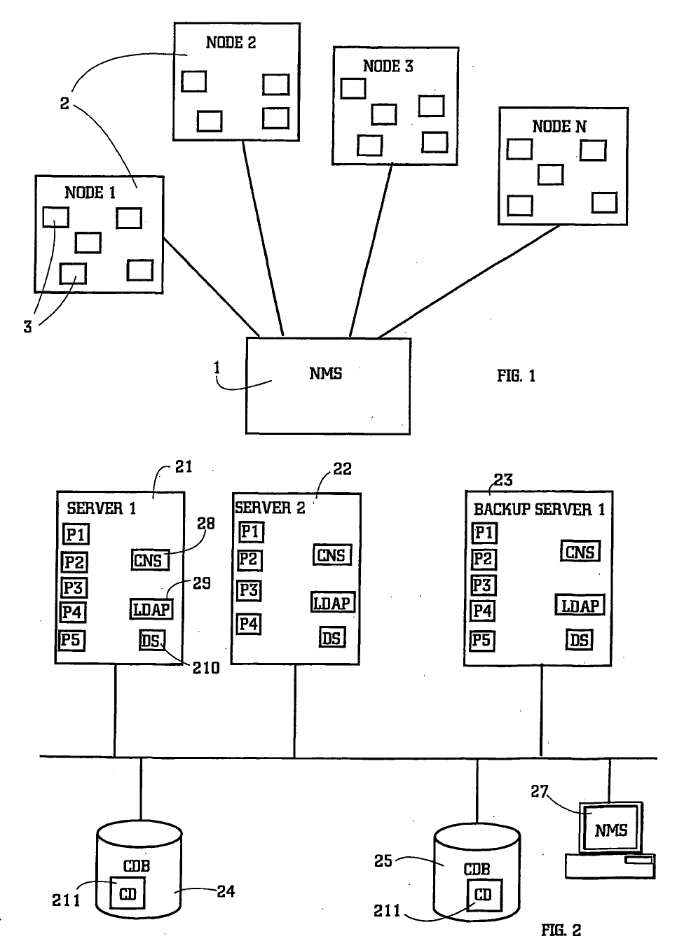

### DETAILED DESCRIPTION OF THE INVENTION

FIG. 2 shows an example of the configuration management according to the invention. Because the configuration management works in a distributed platform, there can be different physical implementations. For example, databases can be situated in servers or in one place, illustrating other choices of implementation than FIG. 2.

The configuration information (CD, 211) of Servers 1 and 2 (21,22) has been stored in a configuration database (CDB) (24). (The database belongs to a distributed directory service (210).) When configuration is desired to be changed, new parameters are stored into the database. A command to change the configuration information can come from the network management (NMS) (27) or an entity, such as a single process in a node that is allowed to do specific changes in configuration data. However, the LDAP (29) does not support distribution of the changes to the processes that are interested in knowing the changes, i.e. the changed parameter values.

The source of the changes, i.e. the network management or the entity,.sends a notification message to the CNS (28). Other processes that are interested in changes of these particular parameter values get the notification from the CNS after which they can change their own parameter values. So the notification message contains the new parameter values. FIG. 2 also shows a back-up server (23) for Server 1 and a back-up configuration database (25). The back-up server must contain the same information as the primary database, so the changes in the configuration information must be updated into both databases. The changes in the back-up system can be done through the CNS.

Configuration management is based on a directory service using LDAP. The directory service is a physically distributed, logically centralized repository of infrequently changing data. LDAP is a protocol to retrieve and manage directory information. Recently and still, managing corporate directories is a bit of a mess due to the variety of directories from different manufactures. LDAP offers a good way to access different directories. Although no single directory specification is apparent to become the global standard, many manufactures have started to support LDAP as an access mechanism for their directory products.

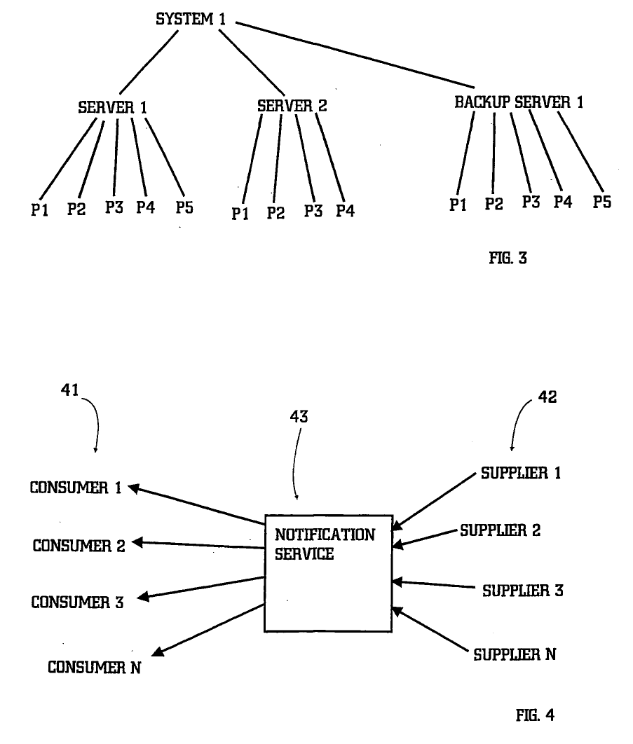

A powerful feature of LDAP is hierarchical naming of directories, which provides an efficient referencing and retrieval of collections of related information, such as system's name, node's name and process's name. FIG. 3 shows an example of the naming of the system according FIG. 2. For example, the name of Process 1 in Server 1 is System/Server 1/P1. The naming system makes it possible to achieve a desired LDAP directory in a simple way.

A drawback of LDAP is that when changes occur in an LDAP directory, it does not inform processes and components, whose configuration information is in that directory, of the changes. Due to this, a notification service, such as CNS (Corba Notification Service), is needed.

Corba is an architecture intended for handling interoperability among a continuously proliferating number of hardware and software products. Corba allows applications to communicate with one another, no matter where they are located. Corba includes a notification service, CNS, that can, for example, transmit information of a change from a supplier (a directory, process or component where the change happened) to a consumer (a directory, process or component) who needs that information.

FIG. 4 shows an example of how CNS works. Consumers (41) are entities in a system, which are interested in knowing changes in another entity. Let's call a change or an occurrence that may be of interest to consumers an event. A consumer can, for example, be a process, database or another component in a distributed- platform. Suppliers (42) are entities that generate events. A component can be a supplier and consumer at the same time concerning different events. The suppliers generate notification messages of events to the CNS (43) that then forwards them to the consumers.

The event communication comprises two models: a push and pull models. In the push model the supplier initiates the transfer of events to the consumers and in the pull model the consumer requests the events from the suppliers. The notification service enables the customers to specify exactly what events are interesting, i.e. CNS offers a filtering function. In other words, the suppliers and consumers are registered in CNS.

As mentioned before, the invention can be implemented in many ways. One way to create the functions of the invention is to use Java, an object-oriented programming language. In this context Java has been used as an example of a tool used for the implementation. For understanding the next description of an implementation of the invention, basic structures of the Java language should be kept in mind. An object is a software component that usually contains an executive code and data. In an object-oriented language actual objects are not defined, but classes of objects are. A class is a template for multiple objects with similar features. It can be said that a class describes all common features for all objects in the class. So, a single object is a concrete representation of the class, in other words an instance.

Methods or logic are functions, i.e. executable codes that operate on a class or an object. A stream or channel is a path of communication between the source of some information and its destination. Java contains several inputstream and outputstream classes for defining different streams. Serializing is a feature in the Java environment that makes it possible to save a state of an instance of the class (the concrete representation of a class) in the form of a byte-line. Serialized instances can be deserialized making it possible to use the saved class representation later. To sum up, a Java application comprises classes, which refer to objects. One of the classes is the “route” class, which contains basic methods of the application and makes it possible to get the other classes that belong to the application. Also the next definitions should be kept in mind:

JSLE Java Service Logic Environment that provides executon of service logic,

SLOP Service Logic Program in JSLE, which provides a platform for actual logic,

SLC Service Logic Component in SLOP, which is a piece of reusable logic. A collection of SLCs models service logic.

FIG. 5 illustrates an example of a node implemented using Java, LDAP and CNS. The node includes JSLE (51) that provides execution of different processes in the node. SLOP (a class) (52) represents a single process and provides a platform for actual logic. SLCs (53) are a piece of reusable logic, i.e. objects, including configuration information. The configuration data is stored in a directory service (54) using a physical database (55). The configuration data contains information about the installed SLOPs, which are found from a database using the LDAP (56) as an access method. The JSLE provides a mechanism to send customized events to a CORBA notification service (57). The notification service uses streams, called notification channels, for receiving and sending events. The notification service also supports the definition of filters for events. The consumers of these events then join the event channels asynchronously. The SLOPs can be registered as consumers for joining the event channels.

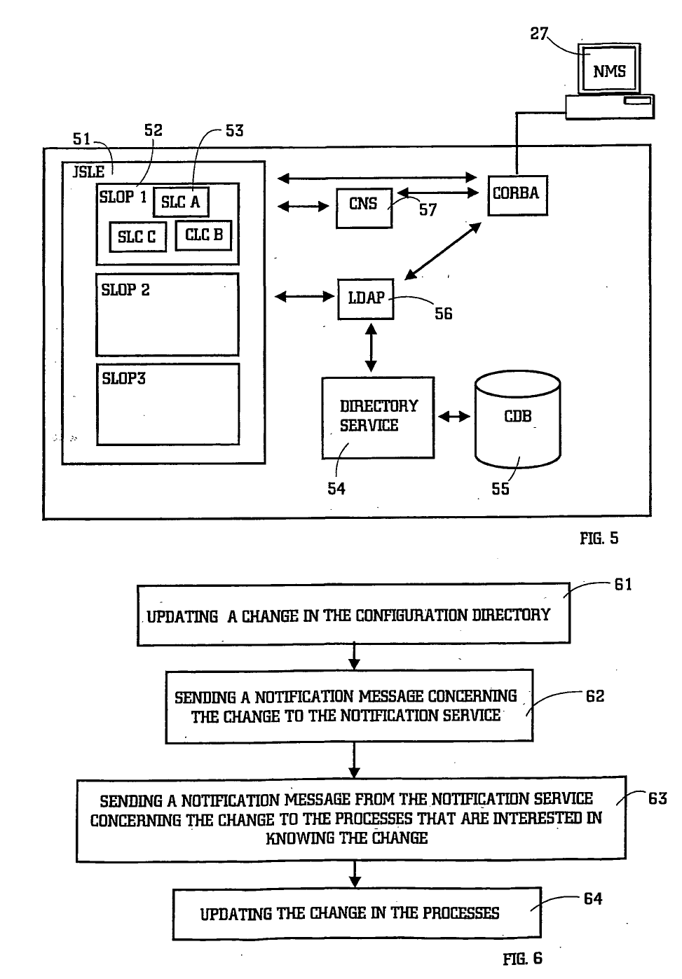

FIG. 6 illustrates an example of a method according to the invention. First, a need to change configuration information comes from the network management or a single component, such as a process, if the component is allowed to do simple changes in the configuration information itself. The change (or changes) has to updated (61) in the configuration directory. So the component or the network management sends updating information to the configuration directory.

Because the configuration directory used (LDAP) does not support distributing the changes to the relevant processes, the component or network management has to send (62) a notification message concerning the change to the notification service used. The message includes information of the relevant processes and channels for distributing the notification. The notification service forwards (63) the notification message to the relevant processes that are interested in knowing the change. After receiving the notification message, the processes can update (64) their configuration.

The composition of LDAP and CNS brings modularity to configuration management. Changes can be distributed to any elements that are interested in knowing and updating the changes even during a run time. Due to this, the updating of back-up systems can be done in real-time, without repeating the actual configuration action.

There are several embodiments concerning which entity is in charge of being the supplier for the said message concerning the change. Several embodiments can be thought of.

In an embodiment of the invention the client requesting a change to the information in the directory (LDAP) can be made responsible for providing to the notification service the message concerning the change. In this embodiment the client requesting a change to the information in the directory first request the change to the directory and then provides to the notification service the message concerning the change. Of course the order of these steps can be inverted. For example, the client when being informed from the directory service that the change request has been accepted and that the database has been updated supplies the message concerning the change to the notification service.

In another embodiment of the invention the directory service has a front end process or a proxy or a mediator service which receives the change requests to the information in the directory. The front end process is responsible for supplying to the notification service the message concerning the change for each accepted update to the directory service. In this embodiment the front end process can in fact have a Corba interface via which the changes to the directory service are issued. In this interface there can be, for example, methods that correspond directly to the operations of the directory service.

In yet another embodiment of the invention the directory service itself supplies the message concerning the change to the notification service. In this embodiment, the directory service could have a first interface which is in accordance with the operation formats from the directory access protocol (e.g. LDAP) and a second interface which is used to convey change notification messages to the notification service;

In yet another embodiment of the invention, the notification service is used to validate changes to the data in the directory. This means that a notification concerning the change is notified to the owner of the particular data item which is being updated. By the data item owned is meant, for instance, a partition within the overall directory, a part of the overall directory information tree, a specific entry, specific attributes within specified entries or specific attributes within a specific entry. The data item owned could comprise all the attributes within the directory having a specific attribute type. For instance, a given attribute type could be assigned to a given owner process. This means that all changes to attributes of that given type would be reported to the owner.

When receiving the notification, the owner checks that the change conforms to rules concerning the value ranges and semantics of the data. For instance, the owner may check from attribute value updates that the update conforms to the value ranges imposed. If the value to be updated to the directory for the attribute conforms to the rules, the owner acknowledges the update and the information is updated to the directory. The notification to the owner of the data item can be issued by the directory service itself, the updating process, or by a front end process or mediator of the directory. The owner of the data item can be specified in the directory in association with the data item. Alternatively, there could be a separate part of the directory which lists attribute types and their owners. It might be possible that the owner is determined otherwise by mapping the attribute type to the owner process using e.g. a separate table.

It should be noted that the invention is not restricted to the management of configuration information within the directory service. The invention could as well be used in other applications such as for storage of information elements like E-mail addresses and names; telephony names, numbers and terminal addresses. Generally, the directory can store address information for entities (i.e. processes or nodes) implementing some telecommunication services. The directory can also store informational attributes associated with these aforementioned information elements such as alternative addresses or contact criteria.

Although, the invention is described in the text as an implementation created by Java and using Corba notification service and LDAP, it is evident that other corresponding programming languages, directory access protocols and notification services can be used. An arrangement according to the invention can be constructed to be transparent so the arrangement is independent of the different technologies used in the nodes. Due to these, the invention can be used in many different implementations, in the scope of the inventive idea.

1. A method for updating a directory service in a system comprising several clients and at least one directory service containing information containing information that the clients use, characterized in that the method contains the steps of
registering the clients which are interested in updates concerning the at least a portion of the information in the directory service,
updating a directory at a client to update the directory service,
sending the update information to the registered clients from the client
updating the directories of registered clients using the update information.

2. A method according to claim 1, characterized in that in the registering step and the sending step are performed in a notification service.

3. A method according to claim 1 or 2, characterized in that in the updating step a connection to the directory service is created by using a directory access method.

4. A method according to claim 3, characterized in that LDAP is used as the directory access method.

5. A method according to claim 1-4, characterized in that the updating step is accomplished via a mediator service.

6. A method according to claim 5, characterized in that the mediator service send the updating information to the notification service.

7. A method according to claim 5, characterized in that the mediator service uses the standard interface of the directory service.

8. A method according to claim 4, characterized in that the mediator service uses the standard interface of the notification service.

9. A method according to claim 2, 6 or 8, characterized in that the notification service filters the clients that are interested in knowing the updated information.

10. A method according to claim 9, characterized in that a CORBA notification service is used as the notification service.

11. A method according to claim 1-10, characterized in that the clients use program classes and objects for creating the functions of each client, the classes and objects including the client specific information.

12. A method according to claim 11, characterized in that Java programming language is used for creating the classes and objects.

13. A method according to claim 2-12, characterized in that
a) the client sends a request for updating to the directory service,
b) the client sends a message concerning the update to the notification service.

14. A method according to claim 2, characterized in that
a) the client sends a message concerning the update to the notification service,
b) the client sends a request for updating to the directory service.

15. An arrangement for updating a directory service in a system comprising several clients and at least one directory service containing information that clients use, characterized in that the arrangement includes
first means for registering the clients which are interested in updates concerning at least a portion of the information in the directory service,
second means for updating a directory at a client to update the directory service,
third means for sending the update information from the clients to the registered clients to update the directories of the registered clients.

16. An arrangement according to claim 15, characterized in that the arrangement further includes a notification service adapted (1) to receive the update information, and (2) to send the update information to the registered clients.

17. An arrangement according too claim 16, characterized in that the notification service comprises means for registering update information and first means.

18. An arrangement according to claim 17, characterized in that the notification service further comprises means for associating the registered update information with the registered clients.

19. An arrangement according to claim 18, characterized in that the notification service further comprises means for filtering the clients that are interested in the updated information.

20. An arrangement according to claim 16-19, characterized in that the arrangement further comprises a mediator service for handling updating tasks (1) between the clients and the directory service, and (2) between the directory service and the notification service.

21. An arrangement according to claim 20, characterized in that the mediator service further comprises means for handling updating tasks between the clients and the notification service.

22. An arrangement according to claim 16-19, characterized in that a COBRA notification service is used as the notification service.

23. An arrangement according to claim 15-22, characterized in that the clients comprise means for creating functions and means for containing the client specific information.

24. An arrangement according to claim 16-19, characterized in that the directory service comprises the notification service.
